(19) United States
(12) Patent Application Publication
(10) Pub. No.: US 2004/0007172 A1
(43) Pub. Date: Jan. 15, 2004

(54) Tape dispenser

(76) Inventor: Scott L. Sakoff, Miami, FL (US)

Correspondence Address: Martin M. Novack, Esq., 17414 Via Capri East, Boca Raton, FL, 33496, US

(21) Appl. No.: 10/194,733

(22) Filed: Jul. 12, 2002

(51) Int. Cl. B05C 11/02

(52) U.S. Cl. 118/52; 118/326

(57) ABSTRACT

A tape dispenser apparatus includes: a generally egg-shaped hollow housing that has first and second separable longitudinal sections; the first section including an internal annular tape-mounting mandrel on a transverse axis perpendicular to the longitudinal direction of the housing; the housing having a tape slot in the transverse direction; and a cutting blade externally on the housing, spaced from and generally parallel to the tape slot.

### FIELD OF THE INVENTION

This invention relates to improved tape dispensers.

### BACKGROUND OF THE INVENTION

The prior art contains various types of tape dispensers. However, existing tape dispensers suffer one or more of the following drawbacks: inconvenience of tape loading; inconvenience of use; and lack of positional readiness for immediate use, such as when stuck in a drawer or hidden under papers or other items.

It is among the objects of the present invention to address and overcome these and other limitations of prior art tape dispensers.

### SUMMARY OF THE INVENTION

In accordance with an embodiment of the invention, a tape dispenser apparatus is set forth, and includes: a generally egg-shaped hollow housing that comprises first and second separable longitudinal sections; the first section including an internal annular tape-mounting mandrel on a transverse axis perpendicular to the longitudinal direction of the housing; the housing having a tape slot in the transverse direction; and a cutting blade externally on the housing, spaced from and generally parallel to the tape slot.

In one preferred embodiment of the invention, the first and second separable longitudinal sections are press-fit sections. In this embodiment, the housing has a bottom region at the longitudinal wider end thereof, and the housing contains, in the internal bottom thereof, a weight for stabilizing the housing to a stable equilibrium with its bottom side down.

In accordance with a further feature of an embodiment of the invention, the tape slot is located adjacent the top end of the housing, and the region around the slot is shaped to form a simulated roller.

Further features and advantages of the invention will become more readily apparent from the following detailed description when taken in conjunction with the accompanying drawings.

### BRIEF DESCRIPTION OF THE DRAWINGS

FIG. 1 is a perspective view of a tape dispenser in accordance with an embodiment of the invention.

FIG. 2 is a cross-sectional view of the housing sections of the FIG. 1 embodiment.

FIG. 3 is another cross-sectional view of the FIG. 1 embodiment, showing the tape mounting and the simulated roller.

FIGS. 4A and 4B illustrate the separated housing sections of the FIG. 1 embodiment.

FIG. 5 shows a side view of the FIG. 1 embodiment.

### DETAILED DESCRIPTION

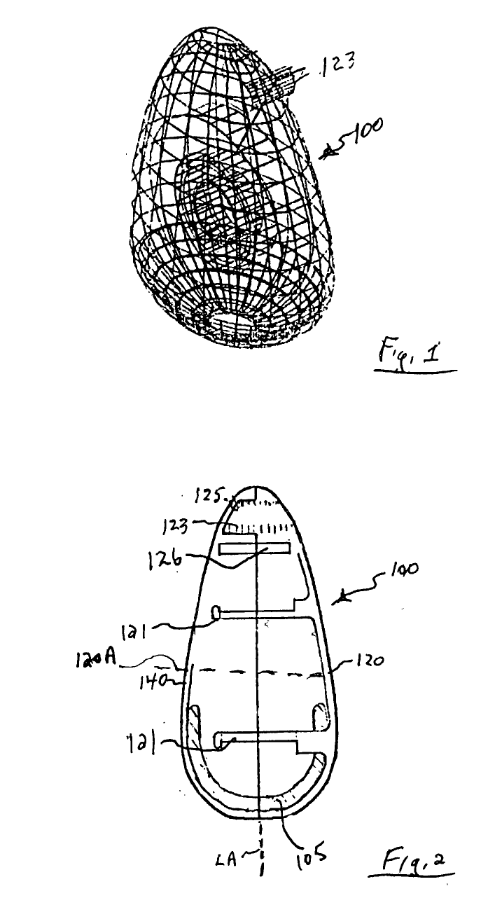

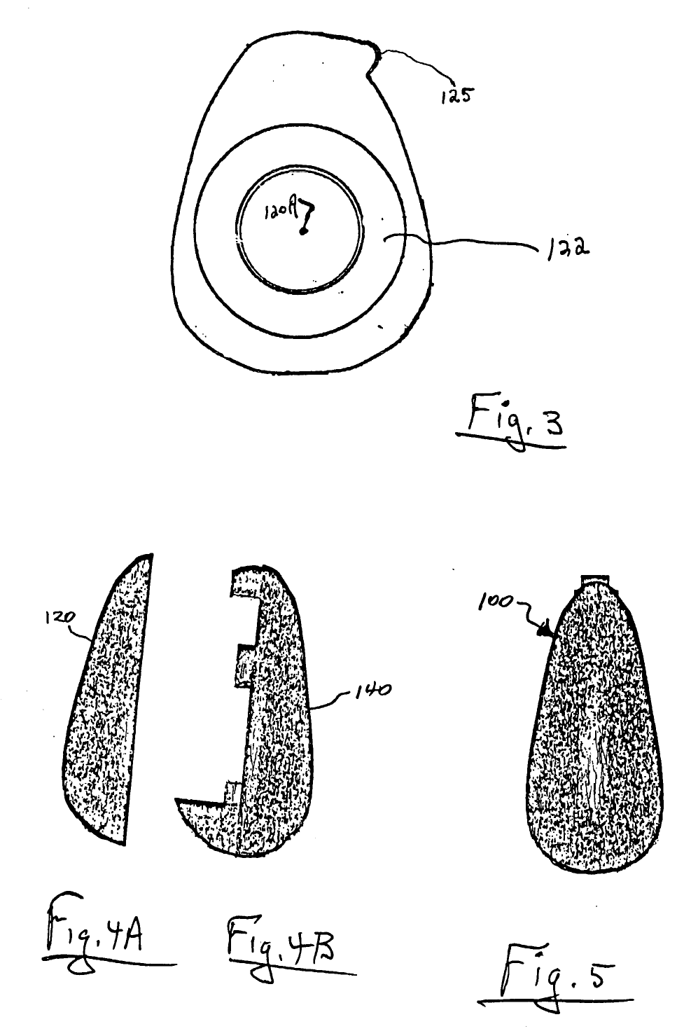

Referring to FIG. 1, there is shown a perspective view of a tape dispenser is accordance with an embodiment of the invention. A generally egg-shaped or ellipsoid-shaped hollow housing 100 includes first and second separable longitudinal sections 120 and 140 (see FIG. 2). The housing may be formed, for example, from a moldable sturdy plastic that can be transparent or partially transparent. In the present embodiment, the plastic sections can be removably press-fit, although it will be understood that other suitable forms of removable connection can be employed.

The section 120 has an a tape-mounting mandrel 121 formed thereon (see also FIG. 3, which shows a standard roll of tape 122 on the mandrel 121), on a transverse axis 120A that is perpendicular to the longitudinal axis (LA) of the housing. A cutting blade 123 is mounted externally on the housing, and, in the present embodiment, is attached to the section 120, which is seen in FIG. 2 to have an overlapping and conforming lip portion 125.

A tape slot 126 is provided in the housing in the transverse direction, parallel to, and spaced from, the cutting blade 123. As seen, for example, in FIG. 2, in the present embodiment, the slot 126 is partially formed in section 120 and partially formed in section 140.

In the illustrated embodiment, the housing has a bottom region at the longitudinally wider end thereof, and the housing contains, in the internal bottom thereof, a weight 105 for stabilizing the housing to a stable equilibrium with its bottom side down. The weight can be any suitable heavy material, for example, lead. As will be understood from FIG. 2, the weight can be mounted in either or both sections, it being mounted in the section 120 in the present embodiment. When the dispenser is laid down, it will return to its stable equilibrium position, and be at the ready for use.

As shown in the FIG. 3 illustration, in an embodiment of the invention, the tape slot can be located adjacent the top end of the housing, with the region around the slot shaped to form a simulated roller.

In operation as a roller, the dispenser is held with one hand and rolled across the surface to be taped. Then, one can pull up to cut the tape once the desired length has been reached. In operation as a conventional tape dispenser, the dispenser is held with one hand and the exposed tape is pulled with the other hand. When the desired length has been reached, one can pull up to cut the tape.

An advantage of the dispenser of the invention is that it can use standard tape rolls which are readily available and economically sensible. The tape can be loaded as follows: First separate the housing by pulling on each side to expose the empty tape roll. Then, insert the new tape roll with sticky side down. Pull out about 2 inches of tape and place it between the guides with sticky side down. Then, snap the two sections of the housing back together.

1. A tape dispenser apparatus, comprising:
a generally egg-shaped hollow housing that comprises first and second separable longitudinal sections;
said first section including an internal annular tape-mounting mandrel on a transverse axis perpendicular to the longitudinal direction of said housing;
said housing having a tape slot in the transverse direction; and
a cutting blade externally on said housing, spaced from and generally parallel to said tape slot.

2. The tape dispenser as defined by claim 1, wherein said first and second separable longitudinal sections are press-fit sections.

3. The tape dispenser as defined by claim 1, wherein said housing has a bottom region at the longitudinal wider end thereof, and wherein said housing contains, in the internal bottom thereof, a weight for stabilizing said housing to a stable equilibrium with its bottom side down.

4. The tape dispenser as defined by claim 2, wherein said housing has a bottom region at the longitudinal wider end thereof, and wherein said housing contains, in the internal bottom thereof, a weight for stabilizing said housing to a stable equilibrium with its bottom side down.

5. The tape dispenser as defined by claim 1, wherein said bottom region includes a generally flat circular center.

6. The tape dispenser as defined by claim 3, wherein said bottom region includes a generally flat circular center.

7. The tape dispenser defined by claim 3, wherein said slot is located adjacent the top end of said housing, and the region around said slot is shaped to form a simulated roller.

8. The tape dispenser defined by claim 6, wherein said slot is located adjacent the top end of said housing, and the region around said slot is shaped to form a simulated roller.

9. The tape dispenser as defined by claim 3, wherein said internal tape-mounting mandrel has an outer diameter adapted to receive a standard roll of tape.

10. The tape dispenser as defined by claim 6, wherein said internal tape-mounting mandrel has an outer diameter adapted to receive a standard roll of tape.

11. The tape dispenser as defined by claim 9, wherein said cutting blade is disposed above said tape slot.

12. The tape dispenser as defined by claim 10, wherein said cutting blade is disposed above said tape slot.

13. The tape dispenser as defined by claim 2, wherein one of said separable sections has a weight mounted therein, said weight having a configuration that extends toward the other of said separable sections and fits therein when said sections are press fit.

14. The tape dispenser as defined by claim 3, wherein one of said separable sections has the weight mounted therein, said weight having a configuration that extends toward the other of said separable sections and fits therein when said sections are press fit.

15. The tape dispenser as defined by claim 7, wherein said one of said separable sections is said first section.

16. The tape dispenser as defined by claim 8, wherein said one of said separable sections is said first section.

17. The tape dispenser as defined by claim 2, wherein one of said separable sections has a portion that extends into the other of said sections.

18. The tape dispenser as defined by claim 17, wherein said one of said sections is said first section.

19. The tape dispenser as defined by claim 2 wherein said sections are formed of plastic.

20. A refillable tape dispenser apparatus, comprising:
a generally ellipsoid-shaped hollow housing that comprises first and second separable longitudinal sections;
said first section including an internal annular tape-mounting mandrel on a transverse axis perpendicular to the longitudinal direction of said housing, said mandrel having an outer diameter adapted to removably receive standard tape rolls;
said housing having a tape slot in the transverse direction; and
a cutting blade externally on said housing, spaced from and generally parallel to said tape slot.
